(19) United States
(12) Patent Application Publication
(10) Pub. No.: US 2013/0088138 A1
(43) Pub. Date: Apr. 11, 2013

(54) LAMP

(71) Applicants: Yasushi Sasai, Saitama (JP); Atsushi Fukuzawa, Saitama (JP); Yukihisa Takeda, Saitama (JP); Kenji Kawajiri, Saitama (JP)

(72) Inventors: Yasushi Sasai, Saitama (JP); Atsushi Fukuzawa, Saitama (JP); Yukihisa Takeda, Saitama (JP); Kenji Kawajiri, Saitama (JP)

(73) Assignee: IWASAKI ELECTRIC CO., LTD., Tokyo (JP)

(21) Appl. No.: 13/805,162

(22) PCT Filed: Jul. 27, 2011
(86) PCT No.: PCT/JP2011/067088

§ 371 Date: Dec. 18, 2012

(30) Foreign Application Priority Data
Aug. 26, 2010 (JP) 2010-189049

(51) Int. Cl. H01J 5/12

(52) U.S. Cl. CPC H01J 5/12
USPC 313/117

(57) ABSTRACT

The present invention relates to a lamp having a spacer which is made of a thin metal plate being put on a closed end of an inner tube and held between the inner tube and the outer tube for keeping a predetermined constant distance therebetween for coaxially arranging the inner tube and the outer tube. In order to reduce the deepness of the shadow caused by strips of the spacer that shield light emitting through the inner tube, the spacer is attached to an exhaust portion protruding from a center of the closed end of the inner tube by inserting the exhaust portion into a hole, and strips, - - - extending in the direction of the opening end of the inner tube from peripheral edge of the center plate are inclined in a circumferential direction around an optical axis of the lamp.

### TECHNICAL FIELD

The present invention relates to a triple tube-type or double tube-type lamp comprising

an inner tube housing an arc tube or a luminous filament,

an outer tube housing the inner tube, and

a base having a mount to which respective open ends of the inner tube and the outer tube are fixed by an adhesive and, it particularly, relates to a lamp in which a spacer made of a thin metal plate and is put on a closed end of the inner tube for coaxially supporting the inner tube to the outer tube.

### BACKGROUND ART

In a triple tube-type metal halide lamp comprising an arc tube, an inner tube housing the arc tube, and an outer tube housing the inner tube, or a double tube-type halogen lamp comprising an inner tube housing a luminous filament and an outer tube housing the inner tube, the inner tube may possibly incline relative to the outer tube when the inner tube and the outer tube covering the inner tube are arranged coaxially and respect open ends of the tubes are fixed to the mount of a base by an adhesive in the manufacturing process, thereby resulting failed products with deteriorated quality of light distribution.

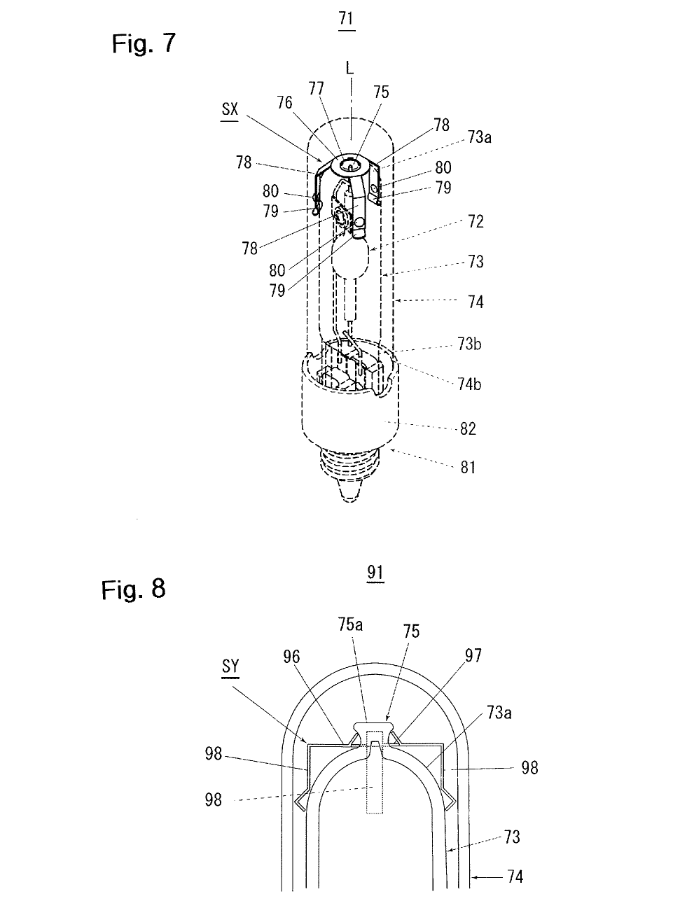

Therefore, in order to prevent the inner tube from inclination, an existent triple tube-type lamp 71 shown in FIG. 7 has a spacer SX which is made of a thin metal plate and attached to a closed end 73a of an inner tube 73 for coaxially supporting the inner tube 73 with respect to the outer tube 74 keeping a predetermined gap therebetween (refer to Patent Literature 1)

The spacer SX has a circular center plate 76 which is attached to an exhaust portion 75 protruding from the center of a closed end 73a of the inner tube 73, with the exhaust portion 75 being inserted into a circular hole 77 of the plate 76, and three strips 78, - - - which extend in the direction of the open end 73b of the inner tube 73 each protruding at an equal distance along the peripheral edge of the center plate 76. Each top end of the strips 78 is bent so as to protrude inward in an arcuate shape to form an arcuate surface 79 in contact with the outer surface of the inner tube 73, and form an arcuate surface 79 abutting against the outer surface of the inner tube 73 and the top end is bulged outward semi-spherically to form a spherical bulge 80 abutting against the inner surface of the outer tube 74.

As shown in FIG. 7, when the inner tube 73 is covered by the outer tube 74, the strips 78, - - - of the spacer SX attached to the closed end 73a of the inner tube 73 are held between the cylindrical outer surface of the inner tube 73 and the cylindrical inner surface of the outer tube 74 to keep a predetermined gap therebetween thereby coaxially supporting the inner tube 73 with respect to the outer tube 74, so that the inner tube 73 is prevented from inclination when the open end 73b of the inner tube 73 and the open end 74b of the outer tube 74 are fixed by the adhesive to a mount 82 of a base 81.

However, in the lamp 71 of FIG. 7, since each of the strips 78, - - - of the spacer SX extends lengthily in the direction of the open end 73b of the inner tube with the plate surface being faced to the optical axis L of the lamp, in parallel to the optical axis L, a portion of effective light emitting from the arc tube 72 through the inner tube 73 is shielded by the strips 78, - - - to cause a problem that the light utilizing efficiency is significantly lowered, as well as cause uneven lighting intensity or shadows which may incur complaint of quality.

In order to cope with such problems, if strips 78, - - - of the spacer SX are shortened and the top ends thereof are held in the vicinity of the closed end 73a of the inner tube 73 between the inner tube 73 and the outer tube 74, the strips 78, - - - may slip off from between the inner tube 73 and the outer tube 74 by vibrations or impact shocks, and the center plate 76 of spacer SX is detached from the exhaust portion 75 and the spacer SX falls off from the closed end 73a of the inner tube 73 during transportation of the lamp 71 to deteriorate the appearance of the lamp 71 thereby possibly causing complaints quality.

Then, the present applicant proposed a lamp 91 shown in FIG. 8, in which each of strips 98, - - - of a spacer SY attached to a closed end 73a of an inner tube 73 is made shorter than the strip 78 of the spacer SX shown in FIG. 7, top ends of the strips 98, - - - are held between the inner tube 73 and the outer tube 74 near a closed end 73a of the inner tube 73, a top end 75a of an exhaust portion 75 inserted through a hole 97 of a center plate 96 of the spacer SY is formed into a shape enlarged at the top end (stopper-shape) , so as to prevent the spacer SY from falling off the closed end 73a of the inner tube 73, thereby, preventing the center plate 96 of the spacer SY from detaching out of the exhaust portion 75 (refer to Patent Literature 2).

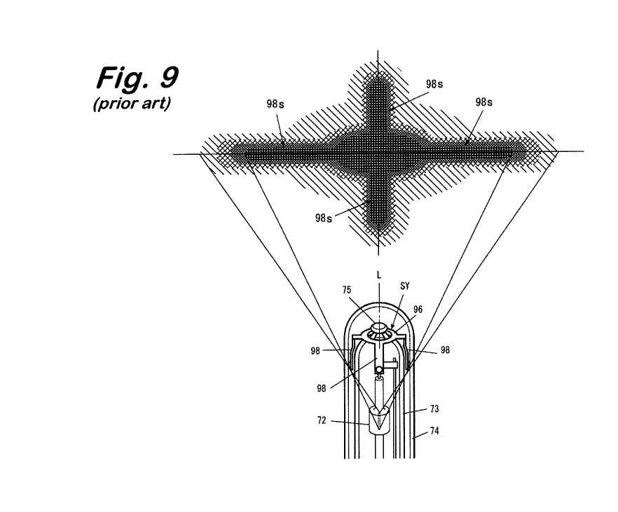

However, when a lamp substantially the same as the lamp 91 shown in FIG. 8 was experimentally manufactured and evaluated by projecting the shadow of the spacer SY resulting from the lamp at close range as shown in FIG. 9, although shadows 98s of respective strips 98, - - - were remarkably shortened by the shortening of the strips 98, - - - of the spacer SY, when the lamp was used for store lighting in which floors and walls are in light plain color, i.e. white, off-white or ivory, shadows 98s - - - of the spacer SY projected on the floors and walls became conspicuous to possibly cause complaints of quality for the lamp since the shadows 98s are deep.

Particularly, since the shadows 98s - - - of the strips 98 - - - extend radially, the shadows, tend to attract attention when they are deep, and there may be a strong possibility of incurring complaints of quality.

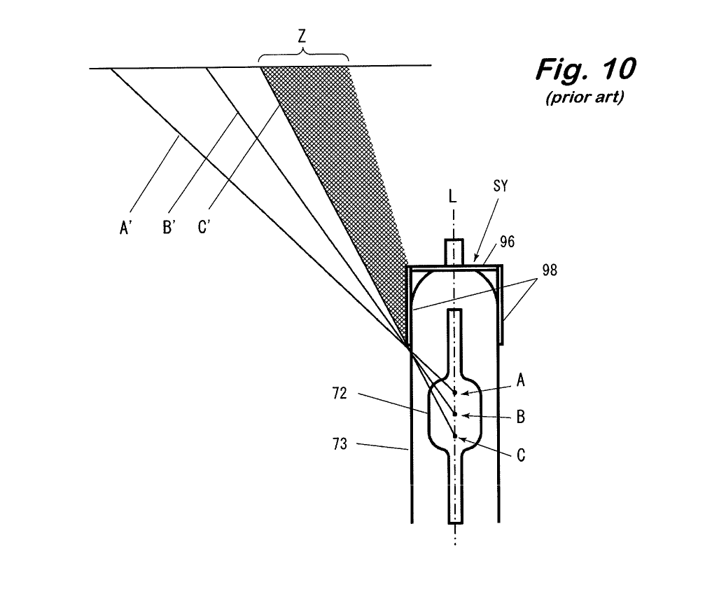

The shadows 98s of the strips 98 of the spacer SY are deep because the strip 98 extends in parallel to the optical axis L of the lamp, as shown in FIG. 10, and light emitting from the points A, B, and C of the arc tube 72 as a light source to the strip 98 is shielded by the strips 98 from lines A′, B′, and C′ that connect the points A, B, and C respectively with the lower ends of the strips 98 of the center-plate 96 of the spacer SY and, particularly, in a zone Z from the line C′ to the center plate 96, all light emitting from the points A, B, and C are shielded by the strips 98.

### CITATION LIST

### Patent Literature

[Patent Literature 1] JP Design Registration No. 1318637

[Patent Literature 2] JP-A 2010-15896

### SUMMARY OF THE INVENTION

### Technical Problem

The present invention relates to a lamp having a spacer which is made of a thin metal plate and attached to a closed end of an inner tube for coaxially supporting the inner tube to an outer tube, and has a technical subject of reducing the deepness of shadows caused by the strips of the spacer that shield light emitted through the inner tube.

### Solution to Problem

In order to solve the problem described above, a lamp according to the present invention comprises:

an inner tube housing an arc tube or a luminous filament,

an outer tube housing the inner tube,

a base having a mount to which each open end of the inner tube and outer tube is fixed by an adhesive, and

a spacer made of a thin metal plate and attached to a closed end of the inner tube so as to coaxially support the inner tube to the outer tube, in which

the spacer has

a center plate which is attached to an exhaust portion protruding from the center of the closed end of the inner tube by inserting the exhaust portion into a hole of the center plate, and

at least three strips protruding from the peripheral edge of the center plate and extending in direction of the open end of the inner tube,

characterized in that

the strips are inclined in a circumferential direction of the inner tube around the optical axis of the lamp.

### Advantageous Effect of the Invention

In the lamp of the present invention, since the strips of the spacer extending in the direction of the open end of the inner tube are inclined in the circumferential direction of the inner tube around the optical axis of the lamp, the lamp provides an excellent effect that the deepness of the shadows caused by the strips that shield the light emitted through the inner tube is entirely reduced compared with the existent lamp having the strips extending in parallel to the optical axis of the lamp.

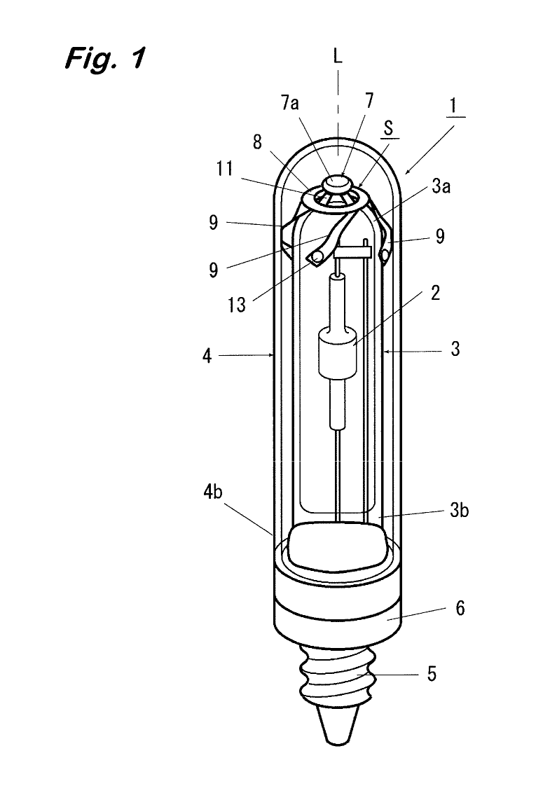

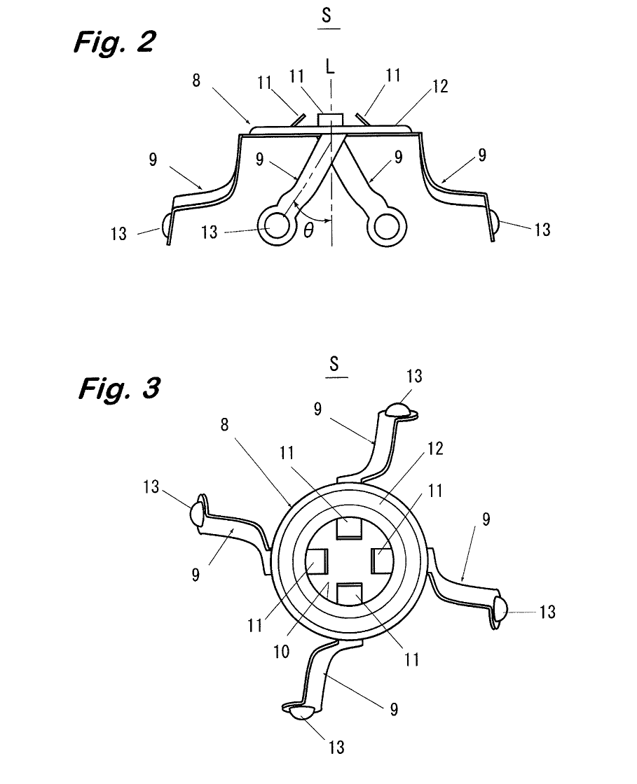

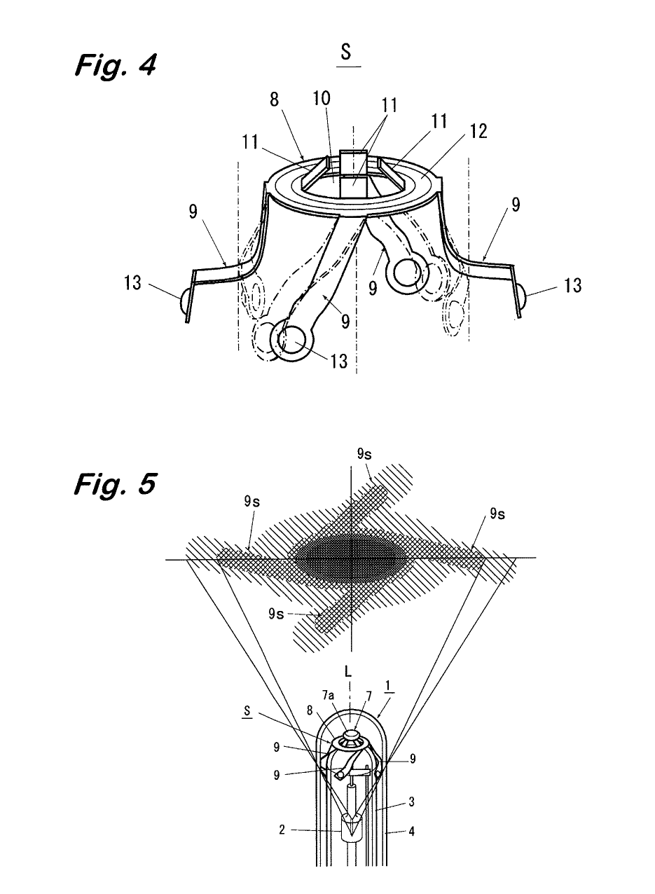

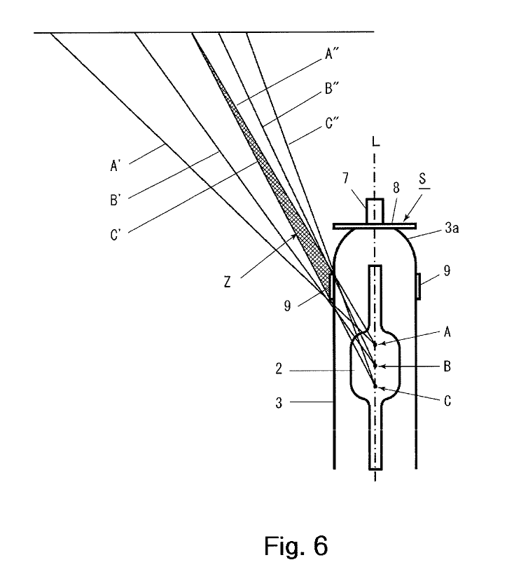

### BRIEF DESCRIPTION OF THE DRAWINGS

[FIG. 1] is a perspective view of a lamp of an embodiment of the present invention.

[FIG. 2] is a front elevational view of a spacer used for the lamp of the embodiment.

[FIG. 3] is a plan view of the spacer used for the lamp of the embodiment.

[FIG. 4] is a perspective view of the spacers used for the of the embodiment.

[FIG. 5] is a schematic view of shadows of the spacers projected by the lamp of the embodiment.

[FIG. 6] is an explanatory view showing the principle of reducing the deepness of the shadows of the strips of the spacer in the lamp of the invention.

[FIG. 7] is a view showing an existent lamp.

[FIG. 8] is a view showing another existent lamp.

[FIG. 9] is a schematic view showing shadows of a spacer projected from the existent lamp.

[FIG. 10] is a view showing the principle that the shadow of strips of a spacer is deep in the existent lamp.

### DESCRIPTION OF EMBODIMENTS

An embodiment of the present invention comprises:

an inner tube housing an arc tube or a luminous filament,

an outer tube housing the inner tube,

a base having a mount to which each open end of the inner tube and outer tube is fixed by an adhesive, and

a spacer made of a thin metal plate and attached to a closed end of the inner tube so as to coaxially support the inner tube to the outer tube, in which

the spacer has

a center plate which is attached to an exhaust portion protruding from a center of the closed end of the inner tube by inserting the exhaust portion into a hole of the center plate, and

at least three or four strips protruding from the peripheral edge of the center plate substantially at an equal distance and extending in direction of the open end of the inner tube.

In order to reduce the deepness of the shadows caused by the strips of the spacer that shield light emitted through the inner tube, the strips are inclined each in the same circumferential direction of the inner tube around the optical axis of the lamp and the angle of inclination is determined as about 15° to 45°.

Further, in order to lock the outer tube detached from the mount of the base by the deterioration of the adhesive that fixes the open end of the outer tube to the mount and inhibit the outer tube from falling, the top ends of the strips of the spacer are urged so as to be resiliently pressed against the inner surface of the outer tube, and the top end an exhaust portion for attaching and supporting the center plate of the spacer is formed into a shape of a stopper for preventing detachment of the center plate.

### Embodiment

A lamp 1 of an embodiment shown in FIG. 1 is a triple tube-type metal halide lamp comprising an inner tube 3 housing an arc tube 2, an outer tube 4 housing the inner tube 3, and a base 5 having a mount 6 of the base 5 to which respective open ends 3b and 4b of the inner tube 3 and the outer tube 4 are fixed by a heat resistant adhesive.

A spacer S made of a thin metal sheet is attached to the closed end 3a of the inner tube 3 such that it intervenes between the inner tube 3 and the outer tube 4 and keeps a predetermined distance between them, thereby coaxially supporting the inner tube 3 to the outer tube 4.

Further, the arc tube 2 is formed of translucent ceramics, and the inner tube 3 and the outer tube 4 are formed of a cylindrical quartz glass tube and a hard glass tube respectively with base ends 3b, 4b thereof being opened, and the spacer S is formed of a stainless spring steel sheet (SUS304-CSP) of 0.2 mm thickness.

Further, the spacer S comprises a ring-shaped center plate 8 attached and supported to an exhaust portion 7 which is protruded to the center at the top end 3a of the inner tube 3 and inserted through a circular hole 10, and four strips 9, - - - protruding from the peripheral edge of the center plate 8 each at 90° interval and extending in the direction of the open end 3b of the inner tube 3.

Then, the strips 9, - - - of the spacer S are formed each to a length of about 7 to 12 mm and a width of about 1.5 to 3 mm) and inclined each in the same circumferential direction of the inner tube 3 around the optical axis L of the lamp 1. The angle θ of inclination is set to a range of about 15° to 45°

The spacer S has four claws 11, - - - to be in contact with the outer periphery of the exhaust portion 7, formed each at an equal distance along the periphery of the circular hole 10 of the center plate 8, and an annular rib 12 is formed within the plane of the center plate 7 for enhancing the mechanical strength thereof, and a spherical bulge 13 abutting against the inner surface of the outer tube 4 is formed to each of the top ends of the strips 9, - - - .

The strips 9, - - - of the spacer attached to the closed end 3a of the inner tube 3 are urged to the inner tube 3 by the outer tube 4 capped over the inner tube 3 as shown in FIG. 1 and deformed resiliently from a state shown by a solid line to a state shown by a chained line in FIG. 4, so that the top end having the spherical bulge 13 urged thereon is in resilient contact with the inner surface of the outer tube 4 by repulsion caused by the resilient deformation.

In the exhaust portion 7 protruding at the center of the closed end 3a of the inner tube 3, the top end 7a in a heat-softened state, when an excessive portion is chipped off by an oxyhydrogen burner, etc. is crushed in an axial direction into a shape enlarged at the top end in the form of a stopper, as shown in FIG. 1, for preventing detachment of the center plate 8 engages the top ends of the claws 11 formed to the center plate 8 of the spacer S to inhibit detachment of the center plate 8.

In the lamp 1 of the embodiment having been constituted as described above, the shadows of the spacer S projected to close range of the lamp is as shown in FIG. 5, and the deepness of the shadows 9s, - - - of the strips, 9, - - - is thinner than the shadows 98s, - - - of the strips 98, - - - of the spacer SY shown in FIG. 9.

The deepness of the shadows 9s, - - - of the strips 9, - - - of the spacer S is reduced by the following reasons. Since the strips 9, - - - are inclined in the circumferential direction of the inner tube 3 around the optical axis L of the lamp 1, a zone where light emitted from the points A, B, and C of the arc tube 2 as the light source is shielded by the strips 9 is restricted to a zone within a narrow angular range formed between lines A′-A″, lines B′-B″, and lines C′-C″ connecting the respective points A, B, and C, and both ends of the strips 9 in the direction of the plate width, and a zone Z where deep shadows are formed by the strip 9 that shield all light emitted from the respective points A, B, C remains in a narrow and short range as shown by hatched lines that disappears if the projection distance is somewhat longer.

Accordingly, when the lamp 1 is used as a store lighting, there is no possibility that the shadows 9s, - - - of the strips 9, - - - of the spacer S projected on the floors or the walls of the store become conspicuous to incur complaints of quality.

According to the experiment of the present inventors, it was confirmed that a sufficient effect of reducing the deepness of the shadows 9s, - - - of the strips 9, - - - is obtained when the angle θ of inclination for the strips 9, - - - of the spacers is adjusted to about 15° or more.

Further, it was confirmed that, when the strips 9, - - - of the spacer S are resiliently biased at the top end so as to press contact the top ends to the inner surface of the outer tube 4, and the top end 7a of the exhaust portion 7 is in the form of a stopper capable of preventing the center plate 8 from detaching as shown in the embodiment, when the outer tube is detached from the base 6 by deterioration of the adhesive for fixing the open end 4b of the outer tube 4 to the mount 5 of the base 6 of the base 5, the strips 9, - - - of the spacer S in resilient contact at the top end thereof with the inner surface of the outer tube 4 are expanded outward undergoing the load of the outer tube 4, by which a force of friction between the top end of the strips 9, - - - and the inner surface of the outer tube 4 increases and the outer tube 4 is locked to the top end of the strips 9, so that dropping thereof can be prevented.

It was further confirmed that when the angle θ of inclination of the strips 9, - - - is defined to about 45° or less, the outer tube 4 can be locked reliably to the top ends of the strips 9, - - - .

While the strips 9, - - - of the spacer S in the embodiment are inclined entirely, the invention is not restricted to such a configuration but the strips 9, - - - may be inclined from an intermediate portion near the peripheral edge to the top end of the center plate 8.

### Industrial Applicability

The present invention improves the quality and the reliability of a triple tube-type lamp comprising an inner tube housing an arc tube, an outer tube housing the inner tube, and a double tube-type lamp comprising an inner tube housing a luminous filament and an outer tube housing the inner tube.

### List of Reference Signs

1 lamp
L optical axis of lamp
2 arc tube
3 inner tube
4 outer tube
5 base
6 mount of base
7 exhaust portion
S spacer
8 center plate
9 strip
10 circular hole
11 claw
12 annular rib
13 spherical bulge

1. A lamp comprising:
an inner tube housing an arc tube or a luminous filament,
an outer tube housing the inner tube,
a base having a mount to which each open end of the inner tube and outer tube is fixed by an adhesive, and
a spacer made of a thin metal plate and attached to a closed end of the inner tube so as to coaxially support the inner tube to the outer tube, in which
the spacer has
a center plate which is attached to an exhaust portion protruding from a center of the closed end of the inner tube by inserting the exhaust portion into a hole of the center plate, and
at least three strips protruding from the peripheral edge of the center plate and extending in direction of the open end of the inner tube, characterized in that
the strips are inclined in a circumferential direction of the inner tube around the optical axis of the lamp.

2. A lamp according to the claim 1, wherein
the strips are protruded each at a substantially equal distance along the peripheral edge of the center plate, and they are inclined each in the same circumferential direction.

3. A lamp according to the claim 1, wherein an angle of inclination of each strip to the optical axis of the lamp is 15 to 45 degree.

4. A lamp according to claim 1, wherein
the free end of each strip is urged so as to be resiliently pressed against the inner surface of the outer tube, and
the top end of the exhaust portion is formed in the shape of a stopper which prevents the center plate from detaching.

5. A lamp according to the claim 2, wherein an angle of inclination of each strip to the optical axis of the lamp is 15 to 45 degree.

6. A lamp according to claim 2, wherein
the free end of each strip is urged so as to be resiliently pressed against the inner surface of the outer tube, and
the top end of the exhaust portion is formed in the shape of a stopper which prevents the center plate from detaching.

7. A lamp according to claim 3, wherein
the free end of each strip is urged so as to be resiliently pressed against the inner surface of the outer tube, and
the top end of the exhaust portion is formed in the shape of a stopper which prevents the center plate from detaching.

8. A lamp according to claim 5, wherein
the free end of each strip is urged so as to be resiliently pressed against the inner surface of the outer tube, and
the top end of the exhaust portion is formed in the shape of a stopper which prevents the center plate from detaching.
